(19) United States
(12) Patent Application Publication
(10) Pub. No.: US 2005/0270281 A1
(43) Pub. Date: Dec. 8, 2005

(54) Liquid crystal display device and driving method thereof

(76) Inventors: Hong Man Moon, Gyeongsangbuk-Do (KR); Su Woong Lee, Gyeongsangbuk-Do (KR); Sung Lim Nam, Seoul (KR)

Correspondence Address: Song K. Jung;MCKENNA LONG & ALDRIDGE LLP, 1900 K Street, N.W., Washington, DC, 20006, US

(21) Appl. No.: 11/143,682

(22) Filed: Jun. 3, 2005

(30) Foreign Application Priority Data
Jun. 3, 2004 (KR) 2004-040464

(51) Int. Cl. G09G 5/00

(52) U.S. Cl. 345/204

(57) ABSTRACT

A liquid crystal display device includes: a plurality of pixels arranged on a substrate; an image display area formed of the plurality of pixels and displaying each image with a different ratio according to a first aspect ratio or a second aspect ratio of image information; plurality of lamps for supplying light to the image display area; control signal generating unit for outputting a first lamp control signal or a second lamp control signal according to the first aspect ratio or the second aspect ratio of the image information; and n inverter for identically driving the amount of light of the lamps when the first lamp control signal is supplied and controlling at least one of the lamps when the second lamp control signal is supplied, so that the liquid crystal display device can prevent deterioration in image quality caused by light leakage and can reduce power consumption.

This application claims the benefit of Korean Patent Application No. 2004-040464, filed on Jun. 3, 2004, which is hereby incorporated by reference for all purposes as if fully set forth herein.

### BACKGROUND OF THE INVENTION

1. Field of the Invention

The present invention relates to a liquid crystal display device and a driving method thereof, and more particularly, to a liquid crystal display device and a driving method thereof preventing light leakage occurring at upper and lower portions of a screen and reducing power consumption by separately controlling lamps.

2. Discussion of the Related Art

Display devices as visual information transfer media have gained more importance in the information society. In order to hold an important position in the future, the display devices should be thin and light, offer lower power consumption and provide high image quality.

Liquid crystal display (LCD) devices display an image by using the refraction anisotropy of liquid crystals and have superior legibility in comparison to the existing cathode ray tub display (CRT). In addition, the LCD devices also have lower average power consumption and heat generation than CRTs having the same screen size.

In general, an LCD device is a flat panel device for displaying a desired image by individually providing image information to pixels arranged in a matrix format and controlling light transmittance of the pixels.

The LCD device includes an LCD panel where a plurality of pixels are arranged in the matrix format, a driving unit for driving the pixels, and a backlight unit for supplying light to the LCD panel.

The LCD panel includes a thin film transistor array substrate and a color filter substrate which face each other and are attached to have an uniform cell-gap and a liquid crystal layer formed on the cell-gap of the color filter substrate and the thin film transistor array substrate.

The backlight unit includes a plurality of lamps and an inverter for supplying power to the lamps. The backlight unit may be one of an edge-type backlight unit in which the lamps are disposed at the side of the LCD panel or a direct-type backlight unit in which the lamps are disposed at the back of the LCD panel.

The edge-type backlight unit is installed at the side of the LCD panel. The edge-type backlight unit evenly diffuses light through a reflecting plate and a light guide plate and supplies the light of the lamps to the LCD panel. Accordingly, because a thin LCD device can be fabricated, the edge-type backlight unit is typically used in a small display device and notebook computers. However, because the light guide plate causes loss of light in the edge-type backlight unit, it is hard to obtain an image of high brightness when the edge-type backlight unit is applied to a large-area LCD panel.

On the other hand, the direct-type backlight unit can provide sufficient brightness regardless of an area of the LCD panel when the number of lamps is increased because the light of the lamps is directly supplied to an entire surface of the LCD panel.

FIG. 1 is a cross-sectional view illustrating a liquid crystal display device to which a direct-type backlight unit is applied.

As illustrated therein, a liquid crystal display device 1 includes: a liquid crystal display (LCD) panel 10 having a first substrate 10a and a second substrate 10b facing each other which are attached at a certain interval and a liquid crystal layer (not illustrated) formed at a space between the first substrate 10a and the second substrate 10b; a backlight unit 40 installed at the back of the LCD panel 10; and a driving unit 50 for driving the LCD panel 10.

Though not illustrated in the drawing, a plurality of gate lines and data lines are horizontally and vertically disposed on the first substrate 10a and cross each other to divide a plurality of pixels. Each of the pixels is provided with a switching device such as a thin film transistor and a pixel electrode.

Red, green and blue color filters are formed on the second substrate 10b and red light, green light and blue light passing through the red, green and blue color filters are mixed to display multiple color images. In addition, a black matrix for preventing light leakage is tightly formed in a net shape at an outer portion of the color filters.

A common electrode is provided at the second substrate 10b to form an electric field on the liquid crystal layer together with the pixel electrode of the first substrate 10a. By changing light transmittance of the liquid crystal layer, the common electrode displays light supplied from the backlight unit 40 as an image.

The backlight unit 40 includes a plurality of lamps 47 for supplying light to the entire surface of the LCD panel 10 by emitting light, a reflecting plate 44 for reflecting the light emitted from the lamps 47 and improving light efficiency, a diffusion plate 45 for diffusing the light emitted from the lamps 47 and making the light incident upon the LCD panel 10, and an optical sheet 46 for re-diffusing the light diffused by the diffusion plate 45, collecting the light and making the light incident upon the LCD panel 10.

The reflecting plate 44 provided at the back of the lamps 47 reflects light exiting the back of the lamps 47 toward the diffusion plate 45 to thereby reduce loss of light and improve uniformity of light made incident upon the diffusion plate 45.

The diffusion plate prevents generation of stains on an image displayed on the LCD panel 10 when light is partially concentrated by diffusing incident light from the lamps 47. A prism sheet refracts the incident light from the diffusion plate at the right angle and collects the light, thereby evenly distributing the light on the entire surface of the LCD panel 10.

The driving unit 50 is divided into a gate driving unit and a data driving unit. The gate driving unit activates the pixels by applying a gate low voltage and a gate high voltage to the gate lines. The data driving unit supplies image information to the pixels through the data lines.

Several components are provided at an outer portion of the LCD panel 10, the driving unit 50 and the backlight unit 40 in order to protect and couple the LCD panel 10, the driving unit 50 and the backlight unit 40. A bottom cover 52 provided at the lower portion of the LCD device 1 protects a lower portion of the backlight unit 40 and supports the LCD panel 10, the driving unit 50 and the backlight unit 40. A top case 51 compresses an edge portion of the LCD panel 10, fixes the LCD panel 10 and is coupled with the side of the bottom cover 52. The top case 51 and the bottom cover 52 are coupled to each other to thereby protect inside attachments.

The above-described direct-type backlight units are mainly used in large-area LCD panels which have been recently fabricated. They are also used in small and medium area LCD panels to obtain higher brightness. The direct-type backlight unit allows to obtain clear image quality through high brightness by supplying light of lamps directly to the entire surface of the LCD panel.

FIG. 2 is a plane view of the LCD device of FIG. 1.

FIG. 2 illustrates the LCD device to which the direct-type backlight unit is applied, in which a top case and an LCD panel are removed to show an arrangement of lamps.

With reference to FIG. 2, a liquid crystal display device includes a plurality of lamps 147 arranged at regular intervals and a reflecting plate 144 installed below the lamps 147 and reflecting light of the lamps 47 upward. Though not illustrated in the drawing, provided are an optical sheet (not illustrated) for diffusing and collecting light of the lamps 147 and providing the light upward, an LCD panel (not shown) where an image is displayed by the light passing through the optical sheet and a top case 151 for compressing an edge portion of the LCD panel and fixing the LCD panel.

As illustrated therein, because the plurality of lamps 147 are arranged at regular intervals and correspond to the entire surface of the LCD panel in the direct-type backlight unit, uniform light of high brightness can be provided to the LCD panel.

In the related art, an LCD device is mainly used as a computer monitor, but a product capable of implementing various screens, for example, direct implementation of a television screen or implementation of a video movie through the LCD device has been developed. Accordingly, because higher brightness than the related art is required to implement various screens, the application of the direct-type backlight unit capable of implementing a screen of high brightness is increasing.

As described in FIG. 1, the LCD panel is installed above the plurality of lamps 147 disposed at regular intervals and the top case compresses the edge portion of the LCD panel and fixes the LCD panel. In general, the LCD panel and the top case are coupled to each other with a minute gap therebetween. However, when the surface of the LCD panel is not flat or when the top case is defective, the top case is adhered to the LCD panel. Like this, when the LCD panel receives direct pressure by the top case, a cell-gap, which is maintained by a fine interval of several micrometers (mm), gets smaller and an arrangement of liquid crystal molecules changes. Because the LCD device controls light transmittance by the arrangement of the liquid crystal molecules, the light transmittance changes when the arrangement of the liquid crystal molecules changes minutely according to a change of the cell-gap.

However, when the top case or the LCD panel is defective, the top case and the LCD panel are not uniformly adhered to each other. Thus, a cell-gap of part where they are adhered to each other is different from that of part where they are not adhered to each other. In addition, an arrangement of the liquid crystal molecules varies according to each part. In particular, because the cell-gap of the part where the top case and the LCD panel are adhered to each other gets thinner, the cell-gap passes more light than a normal cell-gap and therefore stains having high brightness appear at the edge portion of the LCD panel. That is, a phenomenon that light is abnormally leaked through the edge portion of the LCD panel occurs. Such a phenomenon is called a light leakage phenomenon and the stains are referred to as light leakage stains.

The light leakage stains can be a problem particularly when they appear up to part of the image display area in which an image is substantially displayed because of pressure applied to the edge portion of the LCD panel. This case will be described with reference to the accompanying drawings.

FIG. 3A is a view illustrating light leakage stains appearing when a black image is displayed on an entire image display area. FIG. 3B is a view illustrating light leakage stains appearing when an image having a different aspect ratio from the image display area is displayed.

Pixels are arranged in a matrix format on an LCD panel, which includes an image display area for substantially displaying an image by the pixels. The image display area is formed at the LCD panel exposed to the outside except for an area of the LCD panel which is covered by a top case 251. A change of a cell-gap that occurs at the area of the LCD panel which is covered by the top case does not cause a big problem. However, when the change of the cell-gap is generated up to the LCD panel exposed to the outside as shown in FIGS. 3A and 3B and therefore light leakage stains appear, deterioration in image quality occurs.

With reference to FIG. 3A, because the black image is displayed over an entire image display area 272, light leakage stains 270 more clearly contrast with the black image. The lower brightness of the black image is, the more clearly the light leakage stains 270 contrast with the black image. The light leakage stains 270 clearly appear at upper and lower portions of the LCD panel where the top case compresses the LCD panel. The lower brightness of an image which is displayed through the image display area 272 is, the worse image quality is.

When the LCD panel is not used as a computer monitor but used in order to watch TV or see a movie, a full-screen of the image display area 272 is not used in general but an aspect ratio applied to a television broadcast and a movie is applied. FIG. 3B illustrates the light leakage stains 270 appearing on the image display area 272 when an image is displayed at various aspect ratios.

In general, an LCD panel used only as a monitor or an LCD panel used both as a monitor and a television has a ratio of width to height of the image display area 272 of 4:3 (or 1.33:1). This ratio is a standard aspect ratio. An image is displayed to correspond to an entire surface of the image display area 272 according to the standard aspect ratio. However, as a wide aspect ratio of 16:9 (or 1.85:1) or 2.35:1 is applied when making a movie and producing other contents, an image produced in the wide aspect ratio cannot be displayed on the image display area 272 having the standard aspect ratio as a full-screen. Thus, the image does not correspond to the wide aspect ratio. In addition, data of the lowest grey level is supplied to upper and lower portions of the image display area 272, remaining dummy regions except for a region of the image display area 272 where an image is substantially displayed by image information, to thereby display the upper and lower portions as black. However, as illustrated in FIG. 3b, light leakage stains appear on the upper and lower portions of the image display area 272 displayed as black. In particular, because an LCD device which is also used in a television broadcast uses lamps of higher brightness than the LCD only for a monitor, the light leakage stains may clearly appear.

As described, when an image with an aspect ratio different from a full-screen of the image display area 272 is displayed on the image display area 272, image quality of an LCD device may be deteriorated by light leakage stains appearing at an edge portion of the image display area 272. In particular, light of high brightness is leaked, thereby reducing a contrast ratio (C/R).

### SUMMARY OF THE INVENTION

Accordingly, the present invention is directed to a liquid crystal display device and driving method thereof that substantially obviates one or more of the problems due to limitations and disadvantages of the related art.

An advantage of the present invention is to provide a liquid crystal display device and a driving method thereof preventing deterioration in image quality by a light leakage phenomenon occurring at upper and lower portions of an image display area of a liquid crystal display panel.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, there is provided a liquid crystal display device comprising: a plurality of pixels arranged on a substrate; an image display area formed of the plurality of pixels and displaying each image with a different ratio according to a first aspect ratio or a second aspect ratio of image information; a plurality of lamps for supplying light to the image display area; a control signal generating unit for outputting a first lamp control signal or a second lamp control signal according to the first aspect ratio or the second aspect ratio of the image information; and an inverter for identically driving the amount of light of the lamps when the first lamp control signal is supplied and controlling at least one of the lamps when the second lamp control signal is supplied.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view illustrating a liquid crystal display device to which a direct-type backlight unit is applied;

FIG. 2 is a plane view of the LCD device of FIG. 1;

FIG. 3A is a view illustrating light leakage stains appearing when a black image is displayed on an entire image display area;

FIG. 3B is a view illustrating light leakage stains appearing when an image having a different aspect ratio from the image display area is displayed.

FIG. 4 is a view illustrating a liquid crystal display device in accordance with the present invention;

FIG. 5A is an exemplary view illustrating selectively driven lamps in accordance with the present invention; and

FIG. 5B is an exemplary view illustrating an image display area from which light leakage stains are removed by driving the lamps of FIG. 5A.

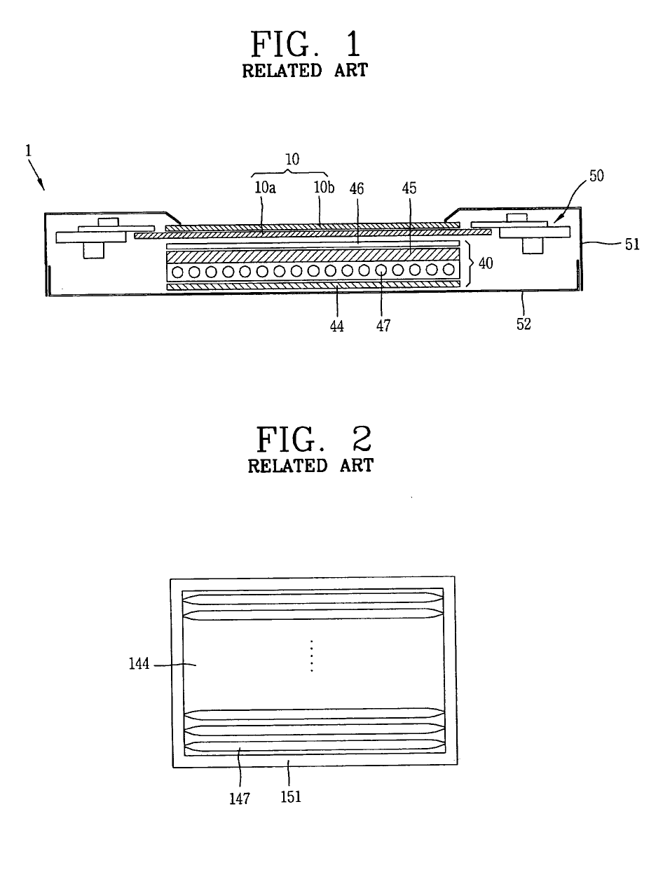

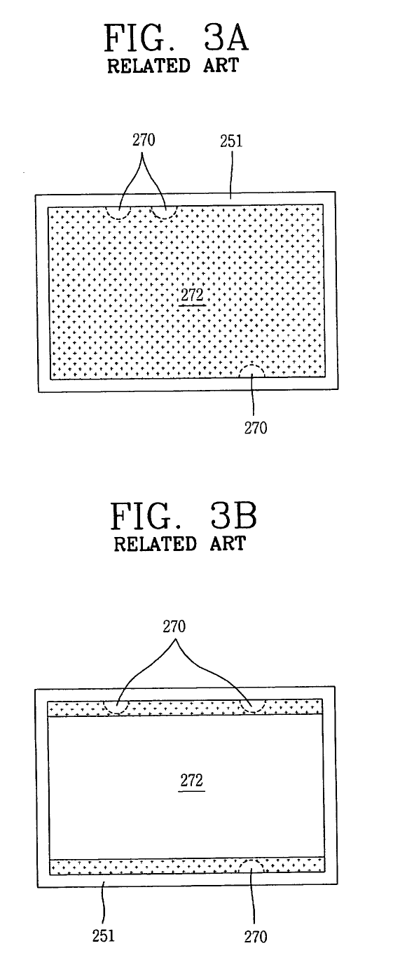

### DETAILED DESCRIPTION OF THE ILLUSTRATED EMBODIMENTS

Reference will now be made in detail to an embodiment of the present invention, example of which is illustrated in the accompanying drawings.

A liquid crystal display device according to the present invention includes a plurality of pixels arranged on a substrate, an image display area for displaying each image with a different ratio according to a first aspect ratio or a second aspect ratio, a plurality of lamps for supplying light to the image display area, a control signal generating unit for outputting a first lamp control signal or a second lamp control signal according to the first aspect ratio or the second aspect ratio, and an inverter for identically driving the amount of light of the lamps when the first lamp control signal is supplied and controlling the amount of light of at least one of the lamps.

The LCD device cannot emit light by itself and therefore has a characteristic of indirectly displaying an image by controlling transmittance of light supplied from lamps.

In the present invention, such a characteristic is used to eliminate a light leakage phenomenon occurring in the image display area. That is, the light leakage phenomenon is reduced by lowering brightness by controlling the amount of light of lamps for supplying light to an area where the light leakage phenomenon occurs among a plurality of lamps. Hereinafter, characteristics of the present invention will be described in detail.

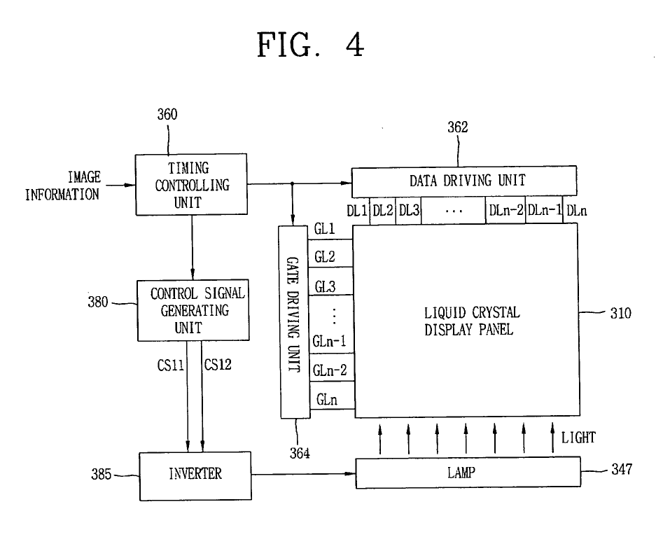

FIG. 4 is a view illustrating a liquid crystal display device in accordance with the present invention.

With reference to FIG. 4, a liquid crystal display (LCD) device includes: an LCD panel 310 in which first and second substrates are attached to each other; at least one lamp 347 for supplying light to the LCD panel 310; a timing controlling unit 360 for generating a plurality of control signals and outputting the control signals with image information; a data driving unit 362 for providing image information to the LCD panel 310 according to the control signals of the timing controlling unit 360; a gate driving unit 364 for supplying scanning signals to the LCD panel 310 according to the control signals of the timing controlling unit 360; a control signal generating unit 380 for selectively outputting a first lamp signal (CS11) or a second lamp signal (CS12) according to an aspect ratio of the image information transmitted from the timing controlling unit 360; and an inverter 385 for separately controlling the amount of light of the lamps 347 according to the first lamp control signal (CS11) or the second lamp control signal (CS12) which is supplied from the control signal generating unit 380.

The LCD panel 310 is fabricated by forming a liquid crystal layer by injecting liquid crystals between the first and second substrates with an uniform cell-gap therebetween. A plurality of data lines (DL1 to DLn) arranged at regular intervals vertically and a plurality of gate lines (GL1 to GLn) arranged at regular intervals horizontally are formed on the first substrate. The data lines (DL1 to DLn) and the gate lines (GL1 to GLn) cross at right angles to thereby divide a plurality of regions. Such regions are pixels. The respective pixels are electrically connected to the data lines (DL1 to DLn) and the gate lines (GL1 to GLn) through thin film transistors (TFTs).

The data lines (DL1 to DLn) are extended and electrically connected to the data driving unit 362. The gate lines (GL1 to GLn) are also extended and electrically connected to the gate driving unit 364.

Though not illustrated in the drawing, the pixels are arranged in a matrix format on the first substrate and constructs an image display area for substantially displaying an image according to image information.

The timing controlling unit 360 receives image information from the outside and generates a plurality of control signals for controlling the data driving unit 362 and the gate driving unit 364.

The timing controlling unit 360 supplies control signals to the gate driving unit 364, and control signals and image information to the data driving unit 362.

When the gate driving unit 364 supplies scanning signals sequentially to the gate lines (GL1 to GLn) by the control signals supplied from the timing controlling unit 360, the thin film transistors of the pixels connected to the corresponding gate lines (GL1 to GLn) are turned on. The data driving unit 362 provides image information to the respective pixels through the thin film transistors while the thin film transistors are turned on.

W liquid crystal molecules corresponding to each of the pixels are re-arranged according to a voltage of the supplied image information, transmittance of light emitted from the lamps 347 is controlled to display an image of various grey levels.

A cold cathode fluorescent lamp (CCFL), an external electrode fluorescent lamp (EEFL) or the like is used as the lamps 347 for supplying light to the LCD panel 310. Here, the CCFL is widely used because it makes a little noise and has low heat generation.

A high voltage is required to diffuse light by discharging the lamps 347. In particular, an alternating current exceeding 2000V is required to discharge the CCFL. Accordingly, because the lamps 347 cannot be driven with a low driving voltage supplied to the LCD device, the inverter 385 capable of forming a voltage to drive the lamps 347 is separately provided. The inverter 385 changes a direct current supplied from the outside into an alternating current of high voltage and supplies the alternating current of high voltage to the lamps 347.

The lamps 347 are disposed at regular intervals at the back of the LCD panel 310. The EEFLs can be driven by one inverter 385, while the CCFLs are driven by the respective inverters 385. Accordingly, the CCFLs consume more power than the EEFLs but can be separately controlled. The present invention uses such a characteristic of the CCFL.

As the top case is compressed into and coupled with the LCD panel 310 when fabricating the LCD device, the light leakage phenomenon occurs by compression pressure of the top case. In the present invention, deterioration in image quality of the LCD device is prevented by eliminating such a light leakage phenomenon which is a problem particularly when the light leakage phenomenon occurs in an image display area.

The light leakage phenomenon mainly occurring at upper and lower portions of the image display area does because a cell-gap of the upper and lower portions of the image display area which are adjacent to part where the LCD panel 310 and the top case are coupled to each other gets thinner and therefore the amount of light being transmitted is increased. Accordingly, leaked light can be reduced or eliminated by controlling the amount of light of the lamps 347 which is supplied to the image display area.

The control signal generating unit 380 outputs the first lamp control signal (CS11) or the second lamp control signal (CS12) for controlling the amount of light of the lamps 347.

The control signal generating unit 380 receives image information from the timing controlling unit 360 and reads information about an aspect ratio included in the image information supplied from various media. The aspect ratio varies according to kinds of media such as a video card, a television reception signal, a digital video disc (DVD) or the like. For example, there can be image information having a standard aspect ratio, a ratio of width to height of 4:3 (or 1.33:1), or image information having a wide aspect ratio of 1.85 or 2.35:1.

When an image is displayed according to image information having the standard aspect ratio, the image is displayed as a full-screen on the image display area. When an image is displayed according to image information having a wide aspect ratio, the image is displayed as a wide screen in which the wide aspect ratio has a wider ratio of width to height than the standard aspect ratio. However, because the wide screen does not correspond to the image display area which is fabricated on the basis of the standard aspect ratio, part of the upper and lower portions of the image display area remains as a dummy region.

As described, when the image is displayed on the image display area according to the standard aspect ratio, the image is displayed to correspond to an entire screen. But, when the image is displayed according to the wide aspect ratio, a dummy region, which is the image display area except for a portion in which the image is displayed, is generated. The dummy region is set to the lowest grey level to thereby be displayed as black.

The light leakage phenomenon is not a big problem for a full-screen where a grey level of an image is continuously changing. But, in a wide screen where the dummy region is continuously displayed as the lowest grey level, the light leakage phenomenon causes a fatal problem in image quality. In order to prevent deterioration in image quality on such a wide screen, the control signal generating unit 380 generates lamp control signals (CS11 and CS12) different from each other according to an aspect ratio of image information. That is, the control signal generating unit 380 determines an aspect ratio of the image information and selectively outputs the first lamp control signal (CS11) or the second lamp control signal (CS12) according to the standard aspect ratio or the wide aspect ratio.

The first lamp control signal (CS11) is outputted when the aspect ratio of the image information is the standard aspect ratio. The second lamp control signal (CS12) is outputted for the wide aspect ratio.

The inverter 385 can control the amount of light emitted by the lamps 347 by controlling an electric current supplied to the lamps 347 according to the first lamp control signal (CS11) or the second lamp control signal (CS12). More specifically, when the first lamp control signal (CS11) is supplied to the inverter 385, the inverter 385 allows identical light to be emitted from all the lamps 347 by identically maintaining an electric current supplied to all the lamps 347. Accordingly, brightness appears uniformly over the entire image display area. On the other hand, when the second lamp control signal (CS12) is supplied to the inverter 385, the inverter 385 controls the amount of light of at least one of the lamps 347. That is, some of lamps 347 are selectively driven.

As described, when the wide screen is displayed, part of the upper and lower portions of the image display area is displayed as the lowest grey level. That is, light transmittance is lowered by re-arranging liquid crystal molecules by supplying arbitrary data to pixels corresponding to the dummy region. However, as the LCD panel is pressed by exterior pressure such as the top case, the cell-gap narrows and therefore a light leakage phenomenon occurs irrespective of the arbitrary data. Thus, the amount of light being emitted is reduced by controlling the lamps 347 which are arranged at the back of the dummy region and supply light to the dummy region.

When the inverter 385 reduces an electric current supplied to the lamps 347 corresponding to the dummy region according to the second lamp control signal (CS12), the light leakage phenomenon occurring at the upper and lower portions of the image display area. At this time, when the electric current supplied to the lamps 347 is minimized, the amount of light of the lamps 347 can be minimized to thereby eliminate the light leakage phenomenon.

As described, the number of the lamps 347 controlling the amount of light according to the second lamp control signal (CS12) depends on an aspect ratio. As described, because the wide aspect ratio is various, for example, 2.35:1 and 1.85:1, the second lamp control signal (CS12) outputted from the control signal generating unit 380 varies according to the aspect ratio. According to 2.35:1 or 1.85:1, the image display area has different distribution of the dummy region where an image is not displayed. Therefore the number of lamps 347 of which the amount of light is to be reduced is determined according to an area of the dummy region. For example, because displaying an image with the aspect ratio of 2.35:1 has a wider dummy region than displaying an image with the aspect ratio of 1.85:1, the amount of light of more lamps 347 should be controlled. The number of lamps 347 to be controlled is previously set according to the wide aspect ratio in the control signal generating unit 380. Then, the control signal generating unit 380 outputs the second lamp control signal (CS12) according to the wide aspect ratio.

The selective control of the lamps 347 may be so effective, especially when used in the wide screen. But, it can be applied to the full-screen displayed with the standard aspect ratio. That is, when an image having the lowest grey level appears in a certain pattern at the upper and lower portions of the image display area irrespective of the aspect ratio of the image information, the amount of light of the lamps 347 corresponding to a portion in which the certain pattern appears can be controlled. That is, the amount of light of the lamps 347 is minimized as the inverter 385 supplies the minimum electric current to the lamps 347 or cuts off power supply. Accordingly, the certain pattern appearing at the upper and lower portions of the image display area can be accurately displayed with the lowest grey level, thereby improving a contrast ratio and preventing a light leakage phenomenon.

As described, when the amount of light of some of lamps 347 is reduced, the contrast ratio of the screen is improved and power consumption is reduced. In addition, the life span of the lamps 347 is extended.

So far, the description is made on the basis of a normally black mode LCD device in which a screen is displayed as black in a basic state that the image information is not supplied. Because a basic state of a screen has high brightness in a normally white mode LCD device opposite to the normally black mode LCD device, it is little affected by a light leakage phenomenon.

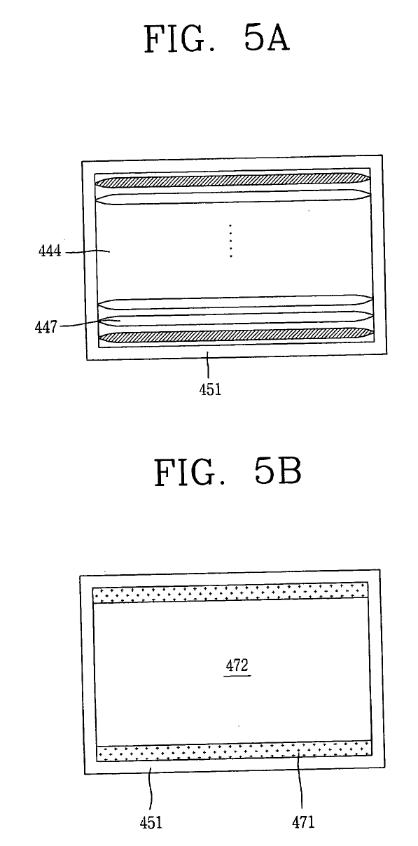

FIG. 5A is an exemplary view illustrating selectively driven lamps in accordance with the present invention. FIG. 5B is an exemplary view illustrating an image display area from which light leakage stains are removed by driving the lamps of FIG. 5A.

FIG. 5A illustrates an LCD device from which an LCD panel and a top case are removed in order to show an arrangement of lamps 447.

With reference to FIG. 5A, the lamps 447 are arranged at regular intervals in the LCD device. A reflecting plate 444 is installed below the lamps 447 to change a direction of light proceeding toward an abnormal direction into an LCD direction.

Though removed from the drawing, an LCD panel (not illustrated) is installed above the lamps 447. Light emitted form the lamps 447 is evenly supplied to an entire surface of the LCD panel.

The lamps 447 displayed as black shows a low brightness state and the lamps 447 displayed as white shows a normal driving state.

As described, the amount of light of some of said lamps 447 is controlled so that the lamps 447 are driven in a low brightness state. Because in general, a light leakage phenomenon appears at the upper and lower portions of the screen where pressure is supplied to the LCD panel, the lamps 447 corresponding to the upper and lower portions of the image display area are controlled. That is, an electric current supplied to the corresponding lamps 447 or electric current supply is cut off.

An image display area 472 in which the lamps 447 are controlled and then a light leakage phenomenon is eliminated is illustrated in FIG. 5B. As described so far, the LCD device selectively controls the amount of light according to the first lamp control signal or the second lamp control signal which is generated according to an aspect ratio of image information, so that a problem of deteriorating image quality because of the light leakage phenomenon occurring at the upper and lower portions of the image display area can be solved.

In addition, when the lowest grey level portion of a certain pattern appears at the image display area, by controlling the amount of light of lamps corresponding to the certain pattern, a contrast ratio of image can be improved and power consumption can be reduced by decreasing the unnecessary driving of lamps.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A liquid crystal display device comprising:
a plurality of pixels arranged on a substrate;
an image display area formed of the plurality of pixels and displaying each image with a different ratio according to a first aspect ratio or a second aspect ratio of image information;
a plurality of lamps for supplying light to the image display area;
a control signal generating unit for outputting a first lamp control signal or a second lamp control signal according to the first aspect ratio or the second aspect ratio of the image information; and
an inverter for identically maintaining the amount of light of the lamps when the first lamp control signal is supplied and controlling the amount of light of at least one of the lamps when the second lamp control signal is supplied.

2. The device of claim 1, wherein the first aspect ratio is a standard aspect ratio for providing a full-screen to the image display area and the second aspect ratio is a wide aspect ratio for providing a wide screen to the image display area.

3. The device of claim 2, wherein the wide aspect ratio has a wider ratio of width to height of the screen than the standard aspect ratio.

4. The device of claim 1, wherein the first aspect ratio is a ratio of width to height of 1.33:1 and the second aspect ratio is a ratio of width to height of 1.85:1.

5. The device of claim 1, wherein the first aspect ratio is a ratio of width to height of 1.33:1 and the second aspect ratio is a ratio of width to height of 2.35:1.

6. The device of claim 1, wherein the plurality of lamps are arranged and correspond to an entire surface of the image display area.

7. The device of claim 6, wherein the lamps are cold cathode fluorescent lamps (CCFLs).

8. A method of driving a liquid crystal display device in which a plurality of pixels are arranged on a substrate, and an image display area formed of the plurality of pixels and substantially displaying an image is provided, comprising:
selectively displaying a full-screen or a wide screen on the image display area according to a first aspect ratio or a second aspect ratio of image information;
outputting a first lamp control signal or a second lamp control signal according to the first aspect ratio or the second aspect ratio of the image information; and
controlling the amount of light of at least one of a plurality of lamps for supplying light to the image display area according to the first lamp control signal or the second lamp control signal.

9. The method of claim 8, wherein a plurality of lamps are arranged by a direct type on an entire surface of the image display area.

10. The method of claim 8, wherein the number of lamps of which light amount is controlled is determined according to the second aspect ratio.

11. The method of claim 10, wherein the lamps corresponding to the remaining portion of the image display area except for a portion in which an image is substantially displayed is controlled according to the second aspect ratio.

12. The method of claim 8, wherein in the step of controlling the amount of light of the lamps, the amount of light of all the lamps are evenly controlled according to the first lamp control signal.

13. The method of claim 8, wherein in the step of controlling the amount of light of the lamps, the amount of light of at least one of the lamps is controlled according to the second lamp control signal.

14. The method of claim 13, wherein the amount of light of lamps corresponding to both edge portions of the image display area is controlled.

15. A liquid crystal display device comprising:
an image display area provided on a substrate, formed of a plurality of pixels and displaying an image;
a plurality of lamps for supplying light to the image display area;
a control signal generating unit for outputting a lamp control signal for controlling the lamps corresponding to a portion of the image display area except for a portion thereof in which an image is displayed according to image information; and
an inverter for controlling the amount of light of at least one of the lamps according to the lamp control signal.
